(19) United States
(12) Patent Application Publication
(10) Pub. No.: US 2015/0143145 A1
(43) Pub. Date: May 21, 2015

(54) INFORMATION PROCESSING APPARATUS, INFORMATION PROCESSING METHOD, AND INFORMATION PROCESSING PROGRAM

(71) Applicant: ASAHI KASEI MICRODEVICES CORPORATION, Tokyo (JP)

(72) Inventors: Kyoya Nakamikawa, Tokyo (JP); Masaya Yamashita, Tokyo (JP)

(73) Assignee: ASAHI KASEI MICRODEVICES CORPORATION, Tokyo (JP)

(21) Appl. No.: 14/406,378

(22) PCT Filed: Jul. 12, 2013
(86) PCT No.: PCT/JP2013/004316

§ 371 Date: Dec. 8, 2014

(30) Foreign Application Priority Data
Jul. 18, 2012 (JP) 2012-159285

(51) Int. Cl. G06F 1/32; G05D 23/19

(52) U.S. Cl. CPC G06F 1/3206; G05D 23/1927
USPC 713/320

(57) ABSTRACT

When an amount of a change of a temperature sensor output value is greater than a threshold, the occupation ratio is updated. When the amount of the change of the temperature sensor output value is equal to or smaller greater than the threshold, the occupation ratio is not updated and the background temperature is updated by using the occupation ratio at the time one sampling period before. When a difference between the temperature sensor output value and the background temperature calculated in this way becomes equal to or smaller than a threshold for an absence stated determination, it is determined an user is in an absence state.

### TECHNICAL FIELD

The present disclosure relates to an information processing apparatus, an information processing method, and an information processing program for processing detection information of a sensor.

### BACKGROUND ART

Conventionally, a variety of technologies for eliminating wasted electricity consumption in an information processing apparatus have been proposed. That is, the information processing apparatus is sometimes left in a state where a user starts but does not use the information processing apparatus. There has been proposed an information processing apparatus capable of detecting such a state and switching itself to a power saving mode.

In PTL 1, for example, a sensor for detecting whether or not the user is present, such as an infrared sensor is provided, and it is detected whether or not the user is in an absence state based on the detection signal of the sensor. Then, when it is determined that the user is in the absence state, for example, a processing such as turning off the power of the screen of the display unit of the information processing apparatus or the like is performed.

### CITATION LIST

### Patent Literature

PTL 1: JP 2012-078959 A

### SUMMARY OF INVENTION

According to one embodiment, there is provided an information processing apparatus, including: an acquisition unit configured to acquire an output from a temperature sensor capable of outputting a signal depending on a temperature within a detection region; an occupation information storage unit in which information relevant to a percentage of a detection object in the detection region is stored as occupation information; a background temperature information storage unit in which background temperature information indicative a temperature of a background except for the detection object within the detection region; and an information update unit configured to update either one information out of the occupation information and the background temperature information based on the output of the temperature sensor and the other information out of the occupation information and the background temperature information.

### BRIEF DESCRIPTION OF DRAWINGS

FIG. 1 is an illustration diagram illustrating an occupancy ratio in one embodiment of the present invention;

FIG. 2 is a schematic configuration diagram of one example of an information processing apparatus to which one embodiment of the present invention is applied;

FIG. 3 is a flowchart indicating one example of a processing procedure in an absence state detection in the first embodiment;

FIG. 4 is a flowchart indicating one example of a processing procedure in a seated state detection;

FIG. 5A to FIG. 5D are timing charts used for illustration of an operation of one embodiment of the present invention; and

FIG. 6 is a flowchart indicating one example of a processing procedure in the absence state detection in the second embodiment.

### DESCRIPTION OF EMBODIMENTS

The information processing apparatus described in PTL 1 has a problem in that, when a temperature environment changes while an input operation of the user is not received, an accurate absence state detection and an accurate seated state detection cannot be performed.

Specifically, in the information processing apparatus described in PTL 1, when an environment temperature rises while the input operation of the user is not received, the output value of the sensor exceeds an reference value even a detection object is absent, and thus it is sometimes determined that the detection object is seated. Conversely, when an environment temperature drops while the input operation of the user is not received, the output value of the sensor falls below the reference value even the detection object is seated, and thus it is sometimes determined that the detection object is absent.

Therefore, embodiments disclosed herein have been conceived of in view of the above problem, and has an object to provide an information processing apparatus, an information processing method, and an information processing program capable of dynamically updating information used as a determination criterion of the presence/absence of a detection object to an appropriate value depending on the change of the temperature environment.

In order to achieve the above mentioned object, according to one embodiment, there is provided an information processing apparatus, including: an acquisition unit configured to acquire an output from a temperature sensor capable of outputting a signal depending on a temperature within a detection region; an occupation information storage unit in which information relevant to a percentage of a detection object in the detection region is stored as occupation information; a background temperature information storage unit in which background temperature information indicative a temperature of a background except for the detection object within the detection region; and an information update unit configured to update either one information out of the occupation information and the background temperature information based on the output of the temperature sensor and the other information out of the occupation information and the background temperature information.

The information processing apparatus may further include a temperature sensor output information storage unit in which information depending on the output of the temperature sensor is stored as temperature sensor output information.

The information processing apparatus may further include a detection temperature information storage unit in which information indicative a temperature of the detection object is stored as detection object temperature information. The information update unit may be is configured to update the either one information out of the occupation information and the background temperature information based on the other information, the output of the temperature sensor, and the detection object temperature information.

According to another embodiment, there is provided an information processing apparatus including: an acquisition unit configured to acquire an output from a temperature sensor capable of outputting a signal depending on a temperature within a detection region; a temperature sensor output information storage unit in which information depending on the output of the temperature sensor is stored as temperature sensor output information; an occupation information storage unit in which information relevant to a percentage of a detection object in the detection region is stored as occupation information; a background temperature information storage unit in which background temperature information indicative a temperature of a background except for the detection object within the detection region; and an information update unit configured to update either one information out of the occupation information and the background temperature information based on the either one information and the temperature sensor output information.

First temperature sensor output information as information depending on the output of the temperature sensor at a first time and second temperature sensor output information as information depending on the output of the temperature sensor at a second time prior to the first time may be stored in the temperature sensor output information storage unit. The information update unit may be configured to take either one of the occupation information and the background temperature information as information to be updated, and is configured to update the information to be update based on the information to be update, the first temperature sensor output information, and the second temperature sensor output information.

The temperature sensor output information storage unit may include a first temperature sensor output information storage unit in which the first temperature sensor output information is stored, and a second temperature sensor output information storage unit in which the second temperature sensor output information is stored.

The information processing apparatus may further include a detection object temperature information storage unit in which information indicative a temperature of the detection object is stored as detection object temperature information. The information update unit may be configured to update the either one information out of the occupation information and the background temperature information based on the either one information, the temperature sensor output information, and the detection object temperature information.

The information update unit may be configured to select the either one information out of the occupation information and the background temperature information as an update target depending on an amount of a change of the output of the temperature sensor.

The information update unit may be configured to select the occupation information as the update target when a value based on the amount of the change of the output of the temperature sensor is greater than a preset threshold value, and is configured to select the background temperature information as the update target when the value based on the amount of the change of the output of the temperature sensor is equal to or smaller than the threshold value.

The information processing apparatus may further include a determination unit configured to determine presence and/or absence of the detection object within the detection region based on the occupation information.

The information processing apparatus may further include a determination unit configured to determine presence and/or absence of the detection object within the detection region based on the output of the temperature sensor and the background temperature information.

The information processing apparatus may further include an occupation information update unit configured to acquire a signal output from an external input device and to update the occupation information stored in the occupation information storage unit depending on the signal output from the external input device.

The occupation information update unit may be configured to update the occupation information to a preset reference value when the occupation information update unit acquires the signal from the external input device.

The external input device may be any one of a mouse, a keyboard, a touch panel, and a vibration detection device.

The information processing apparatus may further include the temperature sensor.

The temperature sensor may be configured to output the signal depending on an absolute amount of the temperature within the detection region.

The temperature sensor may be configured to output the signal depending on the absolute amount of the temperature within the detection region rather than the signal depending on a temperature change of the detection region.

The temperature sensor may be any one of a thermoelectromotive force type infrared sensor, a conductivity type infrared sensor, a photoconduction type infrared sensor, and a photovoltaic type sensor.

According to another embodiment, there is provided an information processing apparatus including: an acquisition unit configured to acquire an output from a temperature sensor capable of outputting a signal depending on an absolute amount of temperature within a detection region; a first information storage unit in which a first information is stored; a background temperature information storage unit in which background temperature information indicative a temperature a background except for the detection object within the detection region; and an information update unit configured to update either one information out of the first information and the background temperature information based on the output of the temperature sensor and the other information out of the first information and the background temperature information.

According to another embodiment, there is provided an information processing apparatus including: an acquisition unit configured to acquire an output from a temperature sensor capable of outputting a signal depending on an absolute amount of a temperature within a detection region; a first information storage unit in which a first information is stored; a background temperature information storage unit in which background temperature information indicative a temperature of a background except for the detection object within the detection region; and an information update unit configured to update either one information out of the first information and the background temperature information based on the either one information and the output of the temperature sensor.

The first information may be information unrelated to the temperature.

The information update unit may be configured to select the first information as an update target when a value based on an amount of a change of the output of the temperature sensor is greater than a preset threshold value, and is configured to select the background temperature information as the update target when the value based on the amount of the change of the output of the temperature sensor is equal to or smaller than the threshold value.

The information processing apparatus may further include a determination unit configured to determine presence and/or absence of the detection object within the detection region based on the first information.

The information processing apparatus may further include a determination unit configured to determine presence and/or absence of the detection object within the detection region based on the output of the temperature sensor and the background temperature information.

The temperature sensor may be configured to output the signal depending on an absolute amount of the temperature within the detection region rather than the signal depending on a temperature change of the detection region.

the temperature sensor may be any one of a thermoelectromotive force type infrared sensor, a conductivity type infrared sensor, a photoconduction type infrared sensor, and a photovoltaic type sensor.

According to another embodiment, there is provided an information processing method include: acquiring an output from a temperature sensor capable of outputting a signal depending on a temperature within a detection region; and updating either one information out of occupation information stored in an occupation information storage unit and background temperature information stored in a background temperature information storage unit based on the output of the temperature sensor and the other information out of the occupation information and the background temperature information, the occupation information indicating information relevant to a percentage of a detection object in the detection region, and the background temperature information indicating a temperature of a background except for the detection object within the detection region.

According to another embodiment, there is provided an information processing method include: acquiring an output from a temperature sensor capable of outputting a signal depending on a temperature within a detection region; and updating either one information out of occupation information stored in an occupation information storage unit and background temperature information stored in a background temperature information storage unit based on the either one information and a temperature sensor output information stored in a temperature sensor output information storage unit, the occupation information indicating information relevant to a percentage of a detection object in the detection region, the background temperature information indicating a temperature of a background except for the detection object within the detection region, and temperature sensor output information depending on the output of the temperature sensor.

According to another embodiment, there is provided an information processing method include: acquiring an output from a temperature sensor capable of outputting a signal depending on an absolute amount of a temperature within a detection region; and updating either one information out of first information stored in a first information storage unit and background temperature information stored in a background temperature information storage unit based on the output of the temperature sensor and the other information out of the first information and the background temperature information, the background temperature information indicating a temperature of a background except for the detection object within the detection region.

According to another embodiment, there is provided an information processing method include: acquiring an output from a temperature sensor capable of outputting a signal depending on an absolute amount of a temperature within a detection region; and updating either one information out of first information stored in a first information storage unit and background temperature information stored in a background temperature information storage unit based on the either one information and the output of the temperature sensor, the background temperature information indicating a temperature of a background except for the detection object within the detection region.

According to another embodiment, there is provided an information processing program for causing a computer to execute the information processing method according to any one of the above embodiments.

It is noted that “updating” described herein means not only updating information stored in a storage unit to another information, but also newly storing information in the storage unit.

Hereinafter, embodiments of the present invention will now be described.

### SUMMARY OF THE EMBODIMENT

The embodiments of present invention use a temperature sensor to detect whether or not there is a detection object in the detection region of the temperature sensor. An explanation will be provided herein for a case where it is detected whether or not a user is present in front of a display unit or near an input device included in an information processing apparatus.

The temperature sensor is disposed at a position such as an upper portion of the display unit included in the information processing apparatus, for example, so that a position of the user performing processing on the information processing unit is included within the detection region of the temperature sensor.

Furthermore, a sensor outputting a signal depending on a temperature, such as an infrared sensor may be employed as the temperature sensor.

The present embodiment apply a temperature sensor capable of detecting an absolute amount of the temperature in the detection region in non-contact manner regardless of the temperature change, rather than a temperature sensor outputting a signal depending on an amount of a change of the temperature in the detection region.

Such a temperature sensor includes a thermoelectromotive force type infrared sensor such as a thermopile or the like, a conductivity type infrared sensor, and a quantum type sensor absorbing an infrared light to output a signal by photoelectric conversion. Examples of the quantum type sensor include a photoconduction type infrared sensor, a photovoltaic type sensor, or the like.

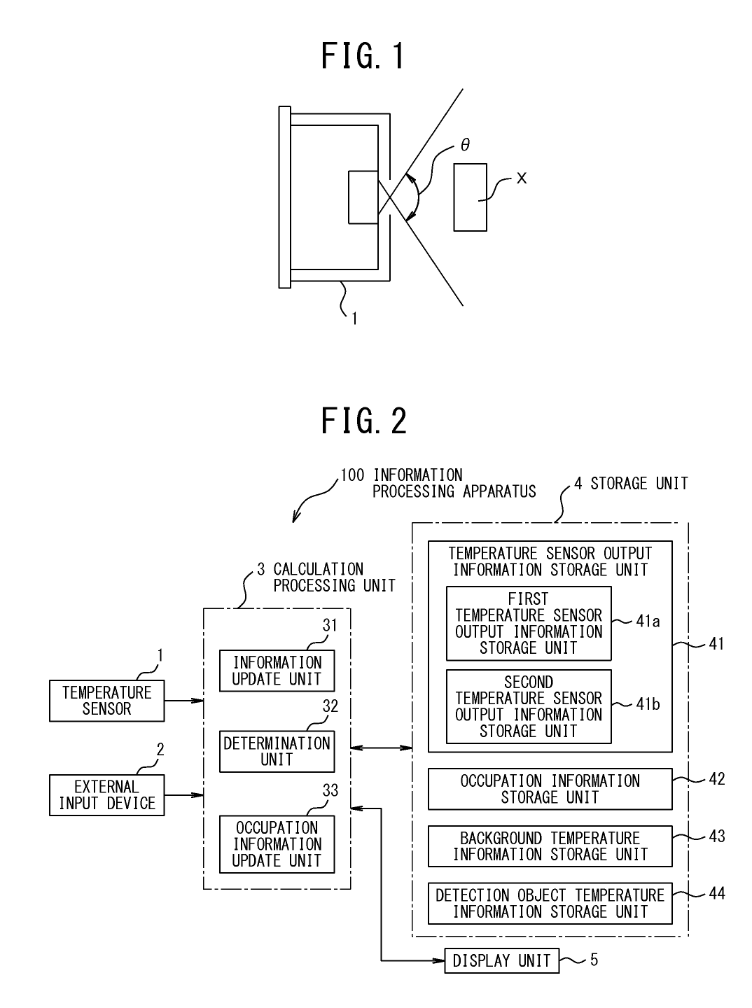

Now, as illustrated in FIG. 1, when θ denotes a viewing angle of the temperature sensor 1, the detection region is the entirety of the inside of the viewing angle θ of the temperature sensor 1.

When Tobs denotes a temperature conversion value (hereinafter, referred to as a temperature sensor output value) of the output signal of the temperature sensor 1, TB denotes the temperature of the background (referred to as a background temperature) except for the detection object X, A denotes a value relevant to the first information, and γ denotes a variable, the embodiments of present invention update the background temperature TB by using the value relevant to the first information satisfying the following expression (1).

Tobs=A+γ·TB (1)

As the first information, for example, a product of a percentage (hereinafter, referred to as an occupancy ratio) of the detection object X in the entirety of the inside of the viewing angle θ and the temperature of the detection object X (hereinafter, referred to as a detection object temperature) is contemplated.

That is, when α denotes the occupancy ratio and TH denotes the detection object temperature, the following expression (1a) is established. It is noted that this expression (1a) is referred to as a basic relational expression, hereinafter.

Tobs=α·TH+(1−α)·TB (1a)

As the temperature sensor output value Tobs, the temperature conversion value of the output signal consistently observed by the temperature sensor 1 may be used. It is noted that a moving average value of the temperature conversion value of the output signal of the temperature sensor 1 may be used as the temperature sensor output value Tobs.

The detection object temperature TH is a human body temperature, since the detection object X is the user herein. The human body temperature is a constant value herein, for example, 34° C. It can be said generally that the temperature conversion value of the human body detected by the temperature sensor 1 is relatively stable near 34° C. Therefore, this value 34° C. is employed as the human body temperature. Hereinafter, an explanation will be provided for a case where the detection object temperature TH is a constant value and the occupancy ratio α is the first information. It should be appreciated that the human body temperature may be a variable.

The background temperature TB is a temperature conversion value of the output signal of the temperature sensor 1 when the detection object X is not present within the viewing angle θ of the temperature sensor 1. Furthermore, when the detection object X is present within the viewing angle θ, the background temperature TB is a temperature conversion value of the output signal of the temperature sensor 1 indicative the temperature of the background except for the detection object X. In this case, a calculation is performed at a constant frequency by using the background temperature TB as a variable used for the absence state detection.

With respect to the occupancy ratio α, it is assumed that a user operating an external input device is present within a range of a certain distance from the temperature sensor 1. And when the external input device is operated, a reference value α0 preset (predetermined) geometrically or experimentally is set as the occupancy ratio α. When the user uses a mouse or a touch panel, or when a vibration is detected by a vibration detection device or the like configured to detect the vibration generated when the user uses the mouse or a keyboard, for example, it can be assumed that the user is present within the range of a certain distance from the temperature sensor 1. Therefore, the reference value α0 is set as the occupancy ratio α, when the keyboard or the mouse is operated or the vibration is detected by the vibration detection device or the like.

The occupancy ratio α in a state where the user operates the keyboard, for example, is around 10%. Therefore, the reference value α0 is set to a value around 10%.

It is noted that even if there is no input received via the external input device, the occupancy ratio α is updated when there is a great change in the temperature sensor output value obtained from the output signal of the temperature sensor 1.

Next, an absence state detection procedure using the basic relational expression (1a) will be described.

That is, the temperature sensor output value Tobs is read at a constant frequency. Then, the background temperature TB is calculated by using the basic relational expression (1a) each time the temperature sensor output value Tobs is read.

As mentioned above, since the occupancy ratio α and the detection object temperature TH are known values, the background temperature TB can be calculated by using the basic relational expression (1a) with the temperature sensor output value Tobs.

The calculated background temperature TB and the temperature sensor output value Tobs are compared, and it is determined that the user is absent when a state satisfying Tobs≦TB continues longer than a preset prescribed period.

That is, when the user is present near the external input device such as the keyboard, the temperature sensor output value Tobs observed by the temperature sensor 1 includes not only the temperature component of the background temperature TB but also the temperature component of the user, since the user is a heating element. Therefore, when the user is present within the viewing angle of the temperature sensor 1, the temperature sensor output value Tobs is predicted to be higher than the background temperature TB (Tobs>TB). In other words, when Tobs≦TB is satisfied, it is predicted that the user is not present near the external input device. Therefore, when Tobs≦TB is satisfied and this state continues longer than the preset prescribed period, it is determined that the user is not present near the external input value. It is noted that, when the background temperature TB is used as it is, the state satisfying Tobs≦TB may not be caused in practice. Thus, a smoothed value of the background temperature TB and the temperature sensor output value Tobs are used and it is determined whether or not the state satisfying “Tobs−Tb≦a threshold value” continues longer than the prescribed period.

In this way, by estimating the background temperature TB from the basic relational expression (1a) by use of the temperature sensor output value Tobs, and comparing the background temperature TB and the temperature sensor output value Tobs, the absence state detection can be performed.

### First Embodiment

Next, the first embodiment of the present invention will be described.

FIG. 2 is a schematic configuration diagram indicative one example of an information processing apparatus 100 according to the first embodiment of the present invention.

The information processing apparatus 100 according to the first embodiment includes a temperature sensor 1, an external input device 2, a calculation processing unit 3, a storage unit 4, and a display unit 5, as illustrated in FIG. 2.

As mentioned above, the temperature sensor 1 is disposed so that its viewing angle includes the position of the user when, for example, the mouse, the keyboard, or the touch panel is used, or the vibration is detected by the vibration detection device or the like configured to detect the vibration generated when the user uses the mouse, the keyboard, or the like. The temperature sensor 1 is disposed, for example, at upper portion of the display unit 5.

The calculation processing unit 3 includes an acquisition unit (not illustrated) configured to acquire the output of the temperature sensor, and is configured to acquire the output of the temperature sensor. Then, the calculation processing unit 3 is configured to perform a calculation processing to detect whether or not the user is present near the external input device 2 on the basis of the detection signal of the temperature sensor 1, that is, whether the user is in the absence state or the seated state. Then, the calculation processing unit 3 configured to display a screen of the display unit 5, or operate in a power saving mode in which the screen brightness is reduced, depending on the attending/seated state of the user. Furthermore, the calculation processing unit 3 configured to perform the processing preset depending on the input operation via the external input device 2 and the processing to display the processing result on the display unit 5, or the like.

Specifically, the calculation processing unit 3 includes an information update unit 31, a determination unit 32, and an occupation information update unit 33.

The information update unit 31 is configured to read the detection signal from the temperature sensor 1 at a constant frequency, and to perform a preset prescribed calculation processing on the basis of the read detection signal and a variety of information stored in the storage unit 4 to update the variety of information stored in the storage unit 4.

The determination unit 32 is configured to determine whether or not the user is present near the external input device 2, that is, whether the user is in the absence state or the seated state, on the basis of the variety of information calculated by the information update unit 31.

The occupation information update unit 33 is configured to update and set the occupancy ratio α described below to a preset reference value α0 when the input operation is performed via the external input device 2.

The storage unit 4 include a storage unit for storing a processing program of the calculation processing in the information processing apparatus 100 for detection the presence or the absence of the user, a processing program used in a variety of calculations, the output signal of the temperature sensor 1 used in the calculation processing, and the variety of information.

Specifically, as illustrated in FIG. 2, the storage unit 4 includes a temperature sensor output information storage unit 41 for storing the temperature sensor output value Tobs based on the output signal of the temperature sensor 1, a occupation information storage unit 42 (a first information storage unit) for storing the occupancy ratio α, a background temperature information storage unit 43 for storing the background temperature TB, and a detection object temperature information storage unit 44 for storing the detection object temperature TH (for example, 34° C. mentioned above as a common human body temperature).

Furthermore, the preset reference value α0 of the occupancy ratio α is stored in the occupation information storage unit 42. The reference value α0 is set to a value, for example 10%, preset geometrically or experimentally, as the occupancy ratio α when the above mentioned user is in a state of using the keyboard.

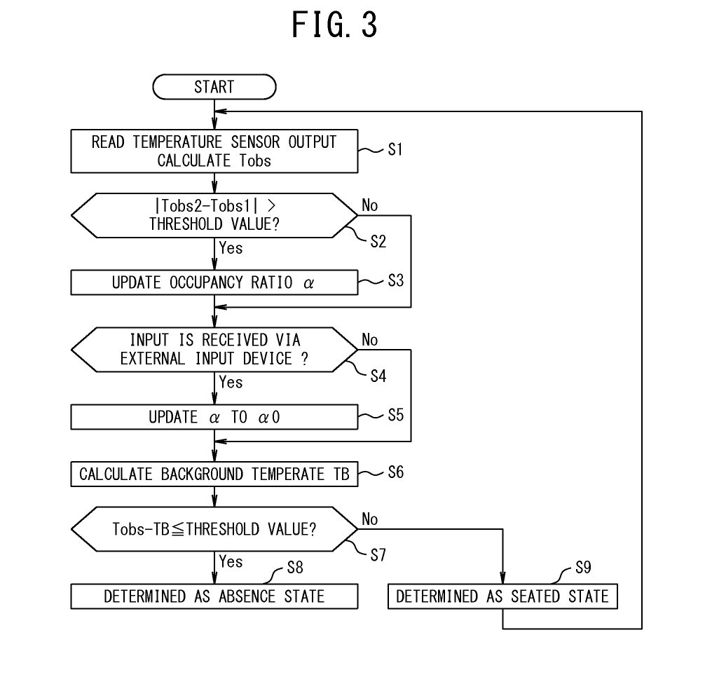

Next, one example of a processing procedure in the calculation processing unit 3 of performing an absence state determination on the basis of the detection signal of the temperature sensor 1 will described below, with reference to a flowchart illustrated in FIG. 3.

When the calculation processing unit 3 receives the output signal of the temperature sensor 1, the calculation processing unit 3 converts the output signal into the temperature conversion value to obtain the temperature sensor output value Tobs (the step S1). Furthermore, the calculation processing unit 3 stores the read temperature sensor output value Tobs in the temperature sensor output information storage unit 41 as the temperature sensor output value at the current sampling timing. In this situation, a region (a first temperature sensor output information storage unit 41a) for storing the temperature sensor output value at the current sampling timing and a region (a second temperature sensor output information storage unit 41b) for storing the temperature sensor output value at the time one sampling period before, for example, are provided in the temperature sensor output information storage unit 41. Then, the calculation processing unit 3 updates the information stored in these storing region (the first temperature sensor output information storage unit 41a, the second temperature sensor output information storage unit 41b) for each sampling period to store at least the temperature sensor output value at the current sampling timing and the temperature sensor output value at the time one sampling period before.

Next, the procedure proceeds to the step S2, it is determined whether or not the temperature sensor output value Tobs changes significantly.

That is, when the amount of change of the temperature sensor output value Tobs per unit time is greater than a preset threshold value, this change of the temperature sensor output value Tobs can be considered not to be due to the change of the temperature environment, and the change of the temperature sensor output value can be considered to be due to the change of the distance between the temperature sensor 1 and the user because of the change of the posture of the user.

Specifically, it is determined whether or not the amount of the change of the temperature sensor output value Tobs per unit time (per one sampling period) is greater than a threshold value for determining whether or not the temperature sensor output value Tobs changes significantly. That is, the absolute value of the difference (Tobs2−Tobs1) between the temperature sensor output value (Tobs2) at the time one sampling period before and the temperature sensor output value (Tobs1) in the current sampling period is obtained. The temperature sensor output value Tobs2 at the time one sampling period before and the temperature sensor output value Tobs1 at the current sampling timing are acquired from the temperature sensor output information storage unit 41.

Then, the absolute value of the difference (Tobs2−Tobs1) of temperature sensor output values is compared with the preset threshold value for determining. When the absolute value of the difference of temperature sensor output values is greater than the threshold value, it is determined that the amount of the change of the temperature sensor output value per unit time is greater than the threshold value, and that the temperature sensor output value changes significantly.

In this way, when it is determined that the temperature sensor output value changes significantly, that is, when it is predicted that the change of the temperature sensor output value is not due to the change of the temperature environment but due to the change of the occupancy ratio of the human body within the viewing angle θ of the temperature sensor 1, the procedure proceeds to the step S3, thus the updating process of the occupancy ratio α is performed.

Specifically, the occupancy ratio α1 satisfying the following expression (2) is obtained.

(Tobs1−α1·TH)/(1−α1)=

(Tobs2−α2·TH)/(1−α2) (2)

In the expression (2), Tobs1 denotes the temperature sensor output value at the current sampling timing, and α1 denotes the occupancy ratio at the current sampling timing. Tobs2 denotes the temperature sensor output value at the time one sampling period before, and α2 denotes the occupancy ratio at the time one sampling period before.

The temperature sensor output value Tobs1 and the temperature sensor output value Tobs2 are acquired from the temperature sensor output information storage unit 41. The occupancy ratio α2 is acquired from the occupation information storage unit 42. The detection object temperature TH is acquired from the detection object temperature information storage unit 44.

Then, the occupancy ratio α1 is calculated from the expression (2) on the basis of the temperature sensor output value Tobs1 at the current sampling timing.

That is, when the temperature sensor output value Tobs changes significantly, it can be predicted that such a change is due to the movement of the human body (the change of the occupancy ratio of the human body). In this situation, the change of the background temperature TB is smaller in comparison with the change of the occupancy ratio of the human body. Therefore, when it is assumed that the background temperature TB is not changed, the following expressions (3) and (4) are established from the basic relational expression (1a).

Then, since it is assumed that the background temperature TB is not changed, the expression (2) can be derived from the expressions (3) and (4).

Tobs1=α1·TH+(1−α1)·TB (3)

Tobs2=α2·TH+(1−α2)·TB (4)

The occupancy ratio α1 acquired from the expression (2) by the calculation is stored in the occupation information storage unit 42 as the occupancy ratio at the current time.

Consequently, the update processing of the occupancy ratio α is completed.

In the step S2, when the absolute value of the difference between the temperature sensor output values (Tobs2−Tobs1) is equal or smaller than the threshold value, the procedure proceeds to the step S4 directly. That is, when the absolute value of the difference between the temperature sensor output values (Tobs2−Tobs1) is equal to or smaller than the threshold value, and thus it is predicted that the occupancy ratio α of the human body within the viewing angle θ is not changed, the procedure proceed to the step S4 without updating the occupancy ratio α.

In the step S4, it is determined whether or not the input is received via the external input device 2 such as the keyboard, the mouse, the vibration detection device 2, or the like.

When the input is received via the external input device 2, the procedure proceeds to the step S5, and the reference value α0 of the occupancy ratio stored in the occupation information storage unit 42 is read out, and the read reference value α0 is set as the occupancy ratio α at the current sampling timing, and the reference value α0 is set in the occupation information storage unit 42 as the updated occupancy ratio at the current sampling timing. Then, the procedure proceeds to the step S6.

On the other hand, when the input is not received via the external input device 2, the procedure proceeds to the step S6 directly.

In the step S6, the background temperature TB is calculated. That is, the background temperature TB is calculated on the basis of the basic relational expression (1a), the occupancy ratio α at the current sampling timing, the detection object temperature TH stored in the detection object temperature information storage unit 44, the temperature sensor output value Tobs at the current sampling timing. When the input is received via the external input device 2, the reference value α0 is set as the occupancy ratio α in the processing of the step S5, thus the occupancy ratio α at the current sampling timing is the reference value α0. Additionally, when the temperature sensor output value Tobs changes significantly, the occupancy ratio α is updated in the step S3, thus, the occupancy ratio α at the current sampling timing is the occupancy ratio updated in the step S3. When the occupancy ratio α is not updated in the step S3, the latest occupancy ratio stored in the occupation information storage unit 42 is used as the occupancy ratio at the current sampling timing.

The background temperature TB calculated in the step S6 is stored in the background temperature information storage unit 43 as the background temperature at the current sampling timing.

Next, the procedure proceeds to the step S7. It is determined whether or not the state in which the difference between the temperature sensor output value Tobs at the current sampling timing and the background temperature TB calculated in the step S6 is equal to or smaller than the preset threshold value for the absence state determination continues for a predetermined period. When the state in which the difference between the temperature sensor output value Tobs and the background temperature TB is equal to or smaller than the threshold value for the absence state determination continues for the predetermined period, the procedure proceeds to the step S8. In this case, it can be predicted that the temperature within the viewing angle detected by the temperature sensor 1 is about equal to the background temperature TB calculated as the background temperature within the viewing angle except for the detection object, and that there is no human body within the viewing angle of the temperature sensor 1. Furthermore, since such a state continues for the predetermined period or longer, it is determined that the user is in the absence state (the step S8). It is noted that the occupancy ratio α may be updated and set to zero when it is determined that the user is in the absence state.

In this way, by performing the processing of, for example, causing the display unit 5 to operate in the power saving mode when it is determined that the user is in the absence state, it is possible to reduce the power consumption of the information processing apparatus 100.

Contrarily, when the difference between the temperature sensor output value Tobs and the background temperature TB is not equal to or less than the threshold value for the absence state determination, or when the difference is equal to or less than the threshold value but such a situation does not continue for the predetermined period or longer, the procedure proceeds to the step S9, and it is determined that the user is in the seated state. That is, when the temperature within the viewing angle detected by the temperature sensor 1 is greater than the background temperature TB calculated as the background temperature except for the detection object, it is determined that the human body as the heating element is present within the viewing angle, that is, it is determined that the user is in the seated state. Or even when the difference between the temperature sensor output value Tobs and the background temperature TB is equal to or smaller than the determination threshold value and when such a state does not continue for the predetermined period or longer, it is not determined the user is absent.

Then, when it is determined that the user is in the seated state, the procedure returns to the step S1, and the monitoring of the output signal of the temperature sensor 1 is continued. Then, when the amount of the change of the temperature sensor output value Tobs is small, the change of the temperature sensor output value Tobs should not be due to the occurrence of a change of the occupancy ratio of the human body within the viewing angle of the temperature sensor 1, and it is hard to say that the user is absent or that the user changes the posture. Therefore, the occupancy ratio α is not updated in the step S3, and the change of the temperature sensor output value Tobs is considered to be due to the change of the environment temperature, and thus only the background temperature TB is updated. Contrarily, when the amount of the change of the temperature sensor output value Tobs is great, the change of the temperature sensor output value Tobs is considered to be due to the occurrence of the change of the occupancy ratio of the human body within the viewing angle of the temperature sensor 1, and the occupancy ratio α is updated in the step S3. By repeating such a processing, when the amount of the change of the temperature sensor output value Tobs is greater than the threshold value, the background temperature TB is updated with the updating of the occupancy ratio α. When the amount of the change of the temperature sensor output value Tobs is equal to or less than the threshold value, the occupancy ratio α is not updated and the latest occupancy ratio stored in the occupation information storage unit 42 is used to update the background temperature TB.

In this way, the occupancy ratio α is updated when it is predicted that the change of the occupancy ratio of the human body occurs within the viewing angle of the temperature sensor 1, and when it is predicted that the change of the occupancy ratio of the human body does not occur, the background temperature TB is updated without updating the occupancy ratio α. Therefore, it is possible to accurately calculate and update the occupancy ratio α and the background temperature TB depending on the occupancy ratio of the human body within the viewing angle.

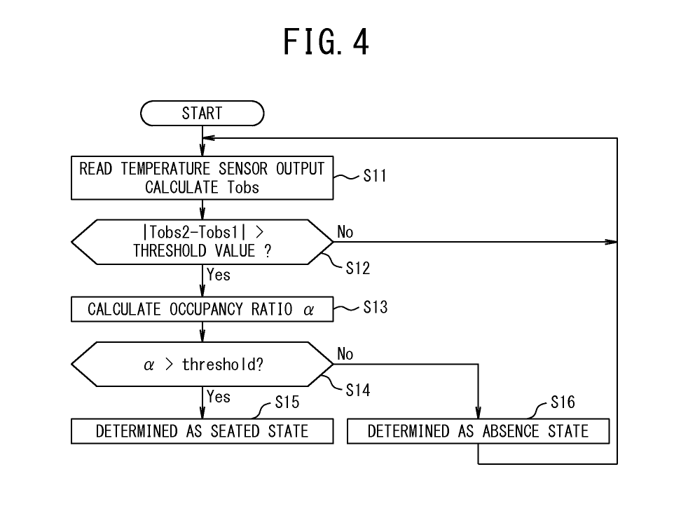

Next, one example of a processing procedure in the calculation processing unit 3 of performing a seated state determination on the basis of the detection signal of the temperature sensor 1 will described below, with reference to a flowchart illustrated in FIG. 4.

When the calculation processing unit 3 receives the output signal of the temperature sensor 1, the calculation processing unit 3 converts the output signal into the temperature conversion value to obtain the temperature sensor output value Tobs (the step S11). Furthermore, the calculation processing unit 3 stores the temperature sensor output value Tobs in the temperature sensor output information storage unit 41.

Next, it is determined whether or not the temperature sensor output value Tobs changes significantly (the step S12). In other words, it is determined that the occupancy ratio of the human body within the viewing angle of the temperature sensor 1. That is, when the amount of the change of the temperature sensor output value per unit time (per one sampling period) is greater than the preset threshold value for determining that the temperature sensor output value changes significantly, this change of the temperature sensor output value can be considered not to be due to the change of the temperature environment, and the change of the temperature sensor output value can be considered to be due to the movement of the human body as the heating element within the viewing angle.

Specifically, the calculation processing unit 3 determines whether or not the amount of the change per unit time (per one sampling period) is greater than the threshold value for determination. That is, the absolute value of the difference (Tobs2−Tobs1) between the temperature sensor output value (Tobs2) at the time one sampling period before and the temperature sensor output value (Tobs1) in the current sampling period is obtained. The temperature sensor output value (Tobs2) and the temperature sensor output value (Tobs1) are acquired from the temperature sensor output information storage unit 41.

Then, the absolute value of the difference (Tobs2−Tobs1) of temperature sensor output values is compared with the preset threshold value. When the absolute value of the difference of temperature sensor output values is greater than the threshold value, it is determined that the temperature sensor output value changes significantly.

Then, when it is determined that the temperature sensor output value Tobs changes significantly, that is, when it is predicted that the occupancy ratio of the human body within the viewing angle of the temperature sensor 1 changes, the procedure proceeds to the step S13, thus the occupancy ratio α after the temperature sensor output value Tobs changes significantly is estimated.

In this situation, the basic relational expression represented by the expression (1a) is established among the temperature sensor output value Tobs, the occupancy ratio α, the detection object temperature TH, and the background temperature TB. Furthermore, when it is assumed that the change of the temperature sensor output value Tobs occurs due to the change of the occupancy ratio of the human body within the viewing angle in the temperature sensor 1, the following expressions (5) and (6) are established.

Tobs1=α1·TH+(1−α1)·TB (5)

Tobs2=TB (6)

It is noted that Tobs1 and α1 in the expressions (5) and (6) denote the temperature sensor output value and the occupancy ratio after the human body enters the viewing angle of the temperature sensor 1 when sitting and the occupancy ratio of the human body is changed, respectively. Tobs2 denotes the temperature sensor output value before the occupancy ratio of the human body within the viewing angle of the temperature sensor 1 changes.

On the basis of these expressions (5) and (6), it is possible to calculate the occupancy ratio α1 after the temperature sensor output value Tobs changes when sitting according to the following expression (7).

Tobs1=α1·TH+(1−α1)·Tobs2 (7)

That is, when Tobs1 denotes the temperature sensor output value at the current sampling timing, and Tobs2 denotes the temperature sensor output value at the time one sampling period before, it is possible to calculate the occupancy ratio α1 after the temperature sensor output value Tobs changes when sitting, that is, the occupancy ratio of the human body after change within the viewing angle of the temperature sensor 1, on the basis of two variable including the temperature sensor output value Tobs1 at the current sampling timing and the temperature sensor output value Tobs2 at the time one sampling period before.

The calculated occupancy ratio α is stored in the occupation information storage unit 42 as the occupancy ratio at the current sampling timing.

In this way, when the occupancy ratio α is calculated from the expression (7), the procedure proceeds to the step S14. It is determined whether or not the occupancy ratio α (=α1) is greater than the preset threshold value for the seated state determination. This threshold value is an occupancy ratio in which the user can be considered as being seated and has been obtained by an experiment or the like beforehand. The threshold value for the occupancy ratio in the case where the user is seated at a position distant from the temperature sensor 1 by 70 cm, for example, is set to “0.1 (10%)”.

When it is determined in the step S14 that the occupancy ratio α (=α1) is greater than the threshold value, the procedure proceeds to the step S15, and it is determined that the user is seated.

When the occupancy ratio α (=α1) is equal to or smaller than the threshold value, it is not determined that the user is seated, but it is determined the user is in the absence state (the step S16). Then the procedure returns to the step S11, and the occupancy ratio α1 at the present time is calculated according to the expression (7) when the temperature sensor output value changes significantly.

Then, when the temperature sensor output value Tobs changes significantly, and the occupancy ratio α (=α1) calculated from the expression (7) exceeds the threshold value, it is determined that the user is seated (the step S15).

When it is determined that the user is seated, the information processing apparatus 100 performs the processing of causing the display unit 5, which has been operating in the power saving mode, to operate in a normal mode or the like. As a result, it is possible to cause the display unit 5 to operate in the normal mode at the time when the user is seated before the user operates the external input device 2 such as the keyboard. That is, since the display unit 5 has already been switched to the normal mode at the time the user operates the external input device 2, the user can perform an input operation promptly.

Additionally, when the temperature sensor output value (Tob2−Tob1) is equal to or less than the threshold value in the above mentioned step S12, the difference between the temperature sensor output values Tobs2 and Tobs1 is relatively small, and it is predicted that the change of the temperature sensor output value Tobs is due to the change of the temperature environment. Therefore, the seated state determination is not performed, the procedure returns to the step S11 directly.

In this way, the occupancy rate α is calculated at the time when the temperature sensor output value Tobs changes significantly, and thus it is predicted that the occupancy rate of the human body within the viewing angle of the temperature sensor 1 changes due to, for example, the sitting of the user who has been absent, or the posture change of the user to be poised to operate the external input device 2 such as the keyboard or the mouse. Contrarily, when the change of the temperature sensor output value Tobs is small and it is hard to say that the occupancy rate of the human body within the viewing angle of the temperature sensor 1 is changed, the occupancy rate α is not calculated. Therefore, it is possible to calculate the occupancy rate α accurately and precisely.

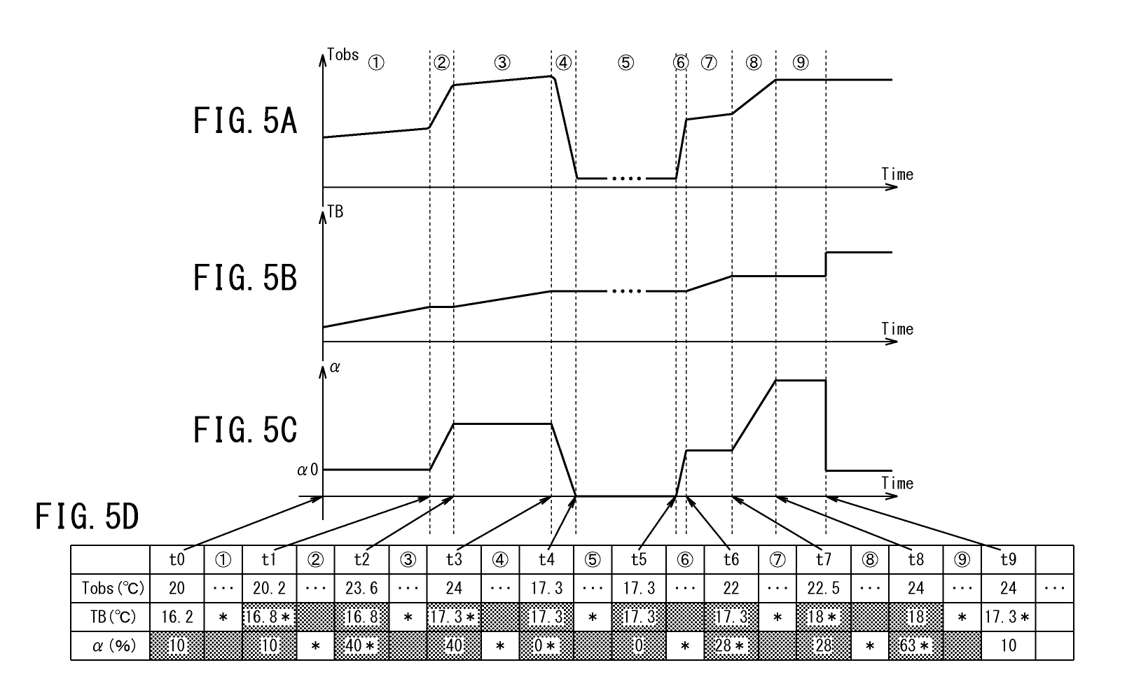

Next, the operation of the first embodiment will be described with reference to a timing chart illustrated in FIG. 5A to FIG. 5D.

FIG. 5A to FIG. 5D indicate one example of the changing situation of the temperature sensor output value Tobs, the background temperature TB, and the occupancy rate α when the user is in the seated state and operates the keyboard.

FIG. 5A represents the temperature sensor output value Tobs, FIG. 5B represents the background temperature TB, FIG. 5C represents the occupancy rate α, and FIG. 5D represents specific examples of the temperature sensor output value Tobs (° C.), the background temperature TB (° C.), and the occupancy rate α (%). It is noted that the symbols “*” in FIG. 5D represent updating and changing are performed per sampling timing. Furthermore, the hatchings represent that the values do not change.

As illustrated in FIG. 5A to FIG. 5D, when the user is in the seated state and operates the keyboard at the time t0, the processing in the absence state detection illustrated in FIG. 3 is performed at this time. Thus, the occupancy ratio α is updated and set to the reference value α0 (10% in the case of FIG. 5A to FIG. 5D).

In the state from the time t0 to the time t1 (the state 1) in which the user maintains the posture at the time when the user operates the keyboard, the temperature sensor output value Tobs obtained at the constant frequency reflects the change of the temperature environment. Thus, while an ambient temperature of the information processing apparatus 100 rises moderately, the temperature sensor output value Tobs also rises moderately. Therefore, the occupancy rate α is not updated and maintains the value at the time t0, and the background temperature TB calculated from the basic relation expression (1a) changes depending on the change of the temperature sensor output value Tobs. That is, while the ambient temperature rises moderately, the temperature sensor output value Tobs also rises moderately, and the background temperature TB calculated from the basic relation expression (1a) also rises moderately.

In the state from the time t1 to the time t2 (the state 2), when the user changes the posture and the sitting position moves forward in the seated state, the user comes close to the temperature sensor 1. Therefore, the occupancy ratio of the user within the viewing angle of the temperature sensor 1 changes.

As a result, the temperature sensor output value Tobs increases significantly. When the amount of the change of the temperature sensor output value Tobs per unit time (one sampling period) exceeds the threshold value, it is determined that the occupancy ratio of the user within the viewing angle of the temperature sensor 1 changes, and the occupancy ratio α at the present time is calculated from the expression (2). While the temperature sensor output value Tobs increases significantly, the occupant ratio α increases accordingly. In this situation, the background temperature TB obtained from the expression (1a), the occupancy ratio α calculated from the expression (2), and the temperature sensor output value Tobs is approximately constant. That is, since it is assumed that the background temperature TB is constant in the calculation process of the occupancy ratio α in the expression (2), the background temperature TB calculated from the expression (1a) is approximately constant.

Furthermore, in this situation, since the temperature sensor output value Tobs is greater than the background temperature TB, and the difference between the temperature sensor output value Tobs and the background temperature TB is greater than the threshold value for the absence state determination, it is determined at this time that the user is in the seated state.

Then, as indicated in the state from the time t2 to time t3 (the state 3), when the user maintains the posture and the ambient temperature of the information processing apparatus 100 rises moderately, the temperature sensor output value Tobs also increases moderately. In this situation, the occupancy ratio α is not updated and is maintained constant, and thus the background temperature TB also increases moderately.

From such a situation, the user in the seated state leaves the seat at the time t3. Upon leaving the seat, the occupancy ratio of the user within the viewing angle of the temperature sensor 1 decreased, thus the temperature sensor output value Tobs decreases significantly. Therefore, while the temperature sensor output value Tobs decreases significantly, the occupancy ratio α is updated, and the calculated occupancy ratio α also decreases with the decrease of the temperature sensor output value Tobs (the state 4 from the time t3 to the time t4).

Then, “the temperature sensor output value Tobs−the background temperature TB” becomes equal to or less than the threshold value for the absence state determination, and at the time when such a situation continues for the prescribed period, it is determined that the user is in the absence state, and the occupancy ratio is set to zero, for example.

While the user is in the absence state (the state 5 from the time t4 to the time t5), since “the temperature sensor output value Tobs−the background temperature TB” is maintained to be equal to or less than the determination threshold value, it is continuously determined that the user is in the absence state, and the occupancy ratio is maintained at zero.

The calculation processing unit 3 performs the processing in the seated state detection illustrated in FIG. 4 instead of the processing in the absence state detection illustrated in FIG. 3, from the time of detection of the absence of the user.

Then, from the absence state, the user sits at the time t5. Upon sitting, the temperature sensor output value Tobs rises. When the temperature sensor output value Tobs increases and the amount of the change per unit time (one sampling period) exceeds the threshold value, the occupancy ratio α is updated (the state 6 from the time t5 to the time t6).

Then, it is determined that the user is in the seated state at the time when the occupancy ratio α exceeds the threshold value for the seated state determination, that is, when the occupancy ratio of the human body within the viewing angle of the temperature sensor 1 becomes great to some extent.

By switching the display unit 5 operating in the power saving mode, for example, to operate in the normal mode in the information processing apparatus 100, at the time when it is determine that the user is in the seated state, it is possible to cause the display unit 5 to operate in the normal mode at the time before the user operates the external input device 2.

From the time of detecting the seated state of the user, the calculation processing unit 3 performs the processing in the absence state detection illustrated in FIG. 3 instead of the processing in the seated state detection illustrated in FIG. 4.

In the state from the time t6 to the time t7 (the state 7) in which the user remains seated and maintains the posture, the temperature sensor output value Tobs rises moderately with the modulate rise in the ambient temperature of the information processing apparatus 100. Thus, the occupancy ratio α is not updated and is constant, and the background temperature TB rises moderately with the change of the temperature sensor output value Tobs.

In the state from the time t7 to the time t8 (the state 8), when the user in the seated state comes close to the temperature sensor 1, for example by changing the posture, the temperature sensor output value Tobs increase in a relatively-rapid manner. Then, when the amount of the change of the temperature sensor output value Tobs exceeds the threshold value, the occupancy ratio α is updated, and the occupancy ratio α increases with the increase of the temperature sensor output value Tobs. In this situation, the calculated background temperature TB is maintained to be approximately constant.

Next, while the user maintains a certain posture (the state 9 from the time t8 to the time t9), the temperature sensor output value Tobs changes moderately with the change of the ambient temperature. Since the amount of the change of the temperature sensor output value Tobs is small, the occupancy ratio α is not updated and maintained to be constant.

Then, when the user operate the external input device 2 such as the keyboard at the time t9, the occupancy ratio α is updated and set to the reference value α0, and the background temperature TB is calculated depending on the reference value α0.

It is noted that it is determined that the user sits at the time when the user sits at the time t5, the display unit 5 is changed from the power saving mode to the normal mode at this time. Therefore, the display unit 5 has operated in the normal mode at the time when the user operates the external input device 2 at the time t9. Therefore, a prompt and usual operation is possible at the time of operating the external input device 2, without a waiting time due to the operation to cause the display unit 5, which has been operating in the power saving mode for example, to operate in the normal mode.

In this way, the background temperature TB is calculated with the calculation of the occupancy rate α on the basis of the temperature sensor output value Tobs, and the absence state is detected on the basis of the calculated back ground temperature TB, the temperature sensor output value Tobs, and the background temperature TB.

Since the absence state is detected on the basis of the magnitude relationship between the difference between the background temperature TB and the temperature sensor output value Tobs, and the determination threshold value, even when the ambient temperature is changed due to the change of the temperature environment, the determination in the absence state detection is not subject to the influence. As a result, it is possible to perform the absence state detection accurately, without the influence from the change of the temperature environment.

Now, the temperature sensor output value Tobs varies due to not only the human body temperature of the user but also the change of the temperature environment. Therefore, in a configuration which performs the absence state determination by comparing between the temperature sensor output value Tobs and the threshold value for the absence state determination, when the ambient temperature rises due to the change of the temperature environment, the temperature sensor output value Tobs rises accordingly. Therefore, the temperature sensor output value Tobs hardly falls below the threshold value for the absence state determination, and it may be erroneously determined that the user is seated even in a case the user is absent actually.

However, the above mentioned embodiment is configured to predict, within the viewing angle, the background temperature TB as a temperature of the background except for the user as the detection object, and to perform the absence state determination on the basis of the difference between the background temperature TB and the temperature sensor output value Tobs, that is, a temperature obtained by eliminating the temperature component of the detection object (the user) within the viewing angle of the temperature sensor 1 from the temperature sensor output value Tobs. That is, the above mentioned embodiment is configure to prevent the difference between the temperature sensor output value Tobs and the background temperature TB, which is a value used for determining of the absence state, from including the component associated with the change of the temperature environment. Therefore, even when the temperature sensor output value Tobs changes due to the change of the temperature environment, it is possible to perform the absence state determination accurately without the influence from the change of the temperature environment, that is, it is possible to improve accuracy of the absence state determination.

Furthermore, since it is possible to determine on the basis of the temperature sensor output value of the one temperature sensor 1, it is possible to perform the absence state determination accurately with a simple configuration.

Additionally, the occupancy ratio α is calculated according to the expression (2) only when the temperature sensor output value Tobs changes significantly and it is predicted the change of the posture of the user occurs, that is, it is predicted that the occupancy ratio of the human body within the viewing angle of the temperature sensor 1 changes, on the assumption that the temperature environment does not change. Therefore, the occupancy ratio α may include an error. However, the occupancy ratio α is used for the absence state determination, and the absence state determination does not demand much accuracy of the occupancy ratio α. Furthermore, the occupancy ratio α is updated and set to the reference value α0 at the time when the external input device 2 such as the keyboard is operated. Then, the reference value α0 is a value obtained on the basis of the occupancy ratio α when the user is seated. Therefore, it is possible to eliminate the error included in the occupancy ratio α each time the external input device 2 is operated, thus the occupancy ratio α can be accurately set. As a result, it is possible to improve estimation accuracy of the background temperature TB, and it is possible to improve the accuracy of the absence state detection.

Furthermore, the above mentioned embodiment is configured to update the occupancy ratio α when the temperature sensor output value Tobs changes significantly on the assumption that this change of the temperature change occurs due to the change of the occupancy ratio of the human body, and to detect the seated state on the basis of the occupancy ratio.

The occupancy ratio α represents the occupancy ratio of the human body within the viewing angle. Therefore, by estimating the occupancy ratio α from the temperature sensor output value Tobs and performing the seated state determination on the basis of the occupancy ratio α, even when the temperature environment changes, it is possible to perform the seated state determination accurately without the influence of the change of the temperature environment.

Furthermore, the occupancy ratio α in the seated state determination is calculated only when the temperature sensor output value Tobs changes significantly and it is predicted that the change of the temperature output value Tobs occurs due to the change of the occupancy ratio of the human body within the viewing angle of the temperature sensor 1, on the assumption that the temperature environment does not change. Therefore, the occupancy ratio α may include the error. However, even when the temperature environment changes, the influence on the temperature sensor output value Tobs is substantially small in comparison with the influence of the change of the occupancy ratio of the human body within the viewing angle of the temperature sensor 1. Therefore, the influence on the occupancy ratio α is relatively small. Furthermore, after the detection of the seated state, the processing in the absence state detection illustrated in FIG. 3 is performed instead of the processing in the seated state detection illustrated in FIG. 4, and the occupancy ratio α is updated to the reference value α0 at the time when the external input device 2 is operated. Therefore, it is possible to eliminate the error included in the occupancy ratio α at this time.

### Second Embodiment

Next, the second embodiment of the present invention will be described.

The second embodiment is similar to the first embodiment except for the processing procedure in the absence state detection, thus the same reference numerals are assigned to the same components, and detailed descriptions thereof are omitted.

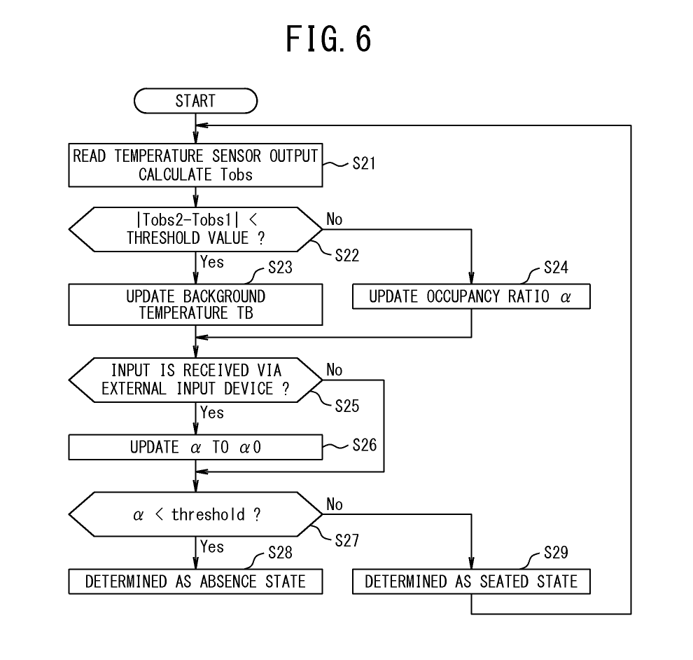

FIG. 6 is a flowchart indicative one example of a processing procedure of the calculation processing unit 3 according to the second embodiment. FIG. 6 indicates one example of the processing procedure of performing an absence state determination on the basis of the detection signal of the temperature sensor 1.

When the calculation processing unit 3 according to the second embodiment receives the output signal of the temperature sensor 1, the calculation processing unit 3 converts the output signal into the temperature conversion value to obtain the temperature sensor output value Tobs (the step S21). Furthermore, the calculation processing unit 3 stores the temperature sensor output value Tobs in the temperature sensor output information storage unit 41.

Then, the procedure proceeds to the step S22. It is determined whether or not the amount of the change of the temperature sensor output value is small, that is whether or not the change of the occupancy ratio of the human body within the viewing angle of the temperature sensor 1 occurs.

Specifically, the absolute value of the difference (Tobs2−Tobs1) between the temperature sensor output value (Tobs2) at the time one sampling period before and the temperature sensor output value (Tobs1) in the current sampling period is obtained. The temperature sensor output values Tobs1 and Tobs2 are acquired from the temperature sensor output information storage unit 41.

Then, when the absolute value of the difference (Tobs2−Tobs1) of temperature sensor output values is smaller than the threshold value, it is determined that the amount of the change of the temperature sensor output value is small. That is, it is determined that the change of the temperature sensor output value is not due to the change of the posture of the user, but due to the change of the temperature environment.

Then, when the amount of the change of the temperature sensor output value is small, the procedure proceeds from the step S22 to the step S23, and the background temperature TB is updated. That is, since it is predicted that when the amount of the change of the temperature sensor output value is small, the change of the posture of the user does not occurs and the change of the temperature sensor output value is due to the change of the temperature environment, the background temperature TB is calculated, and the calculation result is stored in the background temperature information storage unit 43. This calculation of the background temperature TB is performed on the basis of the following expression (8).

(Tobs1−TB1)/(TH−TB1)=

(Tobs2−TB2)/(TH−TB2) (8)

It is noted that TB2 in the expression (8) denotes the background temperature at the time one sampling period before, and is acquired from the background temperature information storage unit 43. It is noted that when the background temperature TB is not updated at the time one sampling period before, the latest background temperature at the time one sampling period before is used as the background temperature at the time one sampling period before.

On the other hand, when it is determined that the amount of the change of the temperature sensor output value is not small, the procedure proceeds to the step S24, and the occupancy rate α is updated. That is, when the amount of the change of the temperature sensor output value cannot be considered to be small, it is predicted that the change of the temperature sensor output value is not due to the change of the temperature environment, but due to the change of the posture of the user, that is, the change of the occupancy ratio of the human body within the viewing angle of the temperature sensor 1. Thus, the occupancy ratio α is calculated. Then, the calculated occupancy ratio is stored in the occupation information storage unit 42.

The calculation of the occupancy ratio α is performed on the basis of the following expression (9).

(Tobs1−α1·TH)/(1−α1)=

(Tobs2−α2·TH)/(1−α2) (9)

It is noted that a2 in the expression (9) denotes the occupancy ratio at the time one sampling period before, and is acquired from the occupation information storage unit 42.

In this way, when the background temperature TB is updated in the step S23 or the occupancy ratio α is updated in the step S24, the procedure proceeds to the step S25.

In the step S25, it is determined whether or not the input is received via the external input device 2 such as the keyboard or the mouse.

When the input is received via the external input device 2, the procedure proceeds to the step S26. The reference value α0 stored in the occupation information storage unit 42 is read out, and is set as the occupancy ratio α at the current sampling timing. Furthermore, the reference value α0 is set in the occupation information storage unit 42 as the updated occupancy ratio at the current sampling timing. Then, the procedure proceeds to the step S27.

On the other hand, when the input is not received via the external input device 2, the procedure proceeds to the step S27 directly.

In the step S27, it is determined whether or not the occupancy ratio α at the current sampling timing is smaller than the threshold value for the absence state determination. Now, when the external input device 2 is operated in the step S25, the occupancy ratio α is the reference value α0. Additionally, when the external input device 2 is not operated in the step S25, the occupancy ratio calculated in the step S24 and stored in the occupation information storage unit 42, or the latest occupancy ratio stored in the occupation information storage unit 42 is used the occupancy ratio α.

Then, when the occupancy ratio α is smaller than the threshold value, the procedure proceeds to the step S28. It is determined that the user is not present within the viewing angle of the temperature sensor 1, that is, the user is in the absence state. It is noted that the occupancy ratio α may be updated and set to zero at this time.

Furthermore, when it is determined that the user is in the absence state in this way, a power consumption reduction of the information processing apparatus 100 may be performed by, for example, causing the display unit 5 to operate in the power saving mode or the like.

On the other hand, when the occupancy ratio α is equal to or greater than the threshold value, the procedure proceeds to the step S29. It is determined that the user is present within the viewing angle of the temperature sensor 1, that is, the user is in the seated state. Then the procedure returns to the step S21.

In this way, also in the second embodiment, when it is predicted from the magnitude of the amount of the change of the temperature sensor output value that the change of the occupancy ratio of the human body within the viewing angle of the temperature sensor 1 occurs, the occupancy ratio α is updated, and when it is predicted that the change of the occupancy ratio of the human body does not occur, the occupancy ratio α is not updated but the background temperature TB is update. Thus, it is possible to update the occupancy ratio α and the background temperature TB accurately and precisely depending on the occupancy ratio within the viewing angle.

Additionally, the occupancy ratio α calculated in this way is a value estimated at the time when the user operates the external input device 2 or the time when the user is predicted to change the posture. That is, the occupancy ratio α represents the occupancy ratio of the user within the viewing angle of the temperature sensor 1, and the absence state detection is performed on the basis of the occupancy ratio. Therefore, even when the temperature environment changes, the determination in the absence state detection is not subject to the influence of the change of the temperature environment. Therefore, it is possible to perform the absence state determination accurately without the influence of the fluctuation of the temperature environment.

Furthermore, also in the second embodiment, the occupancy ratio α is calculated on the basis of the expression (9), only when the temperature sensor output value Tobs changes significantly and it is predicted that the change of the posture of the user occurs, that is, it is predicted that the change of the occupancy ratio within the viewing angle of the temperature sensor 1 occurs, on the assumption that the temperature environment does not change. Therefore, the occupancy ratio α may include an error. However, the occupancy ratio α is updated and set to the reference value α0 at the time when the external input device 2 such as the keyboard is operated. Thus, it is possible to eliminate the error included in the occupancy ratio α each time the external input device 2 operates. As a result, it is possible to improve the estimation accuracy of the background temperature TB, that is, it is possible to improve the accuracy of the absence state detection.

It is noted that although the explanations of the respective above mentioned embodiments are mainly given for the case where the first information is the occupancy ratio α, the first information is not limited to the occupancy ratio α. The first information may be any value which satisfies the expression (1) without being limited to specific one.

Furthermore, the explanations of the respective above mentioned embodiments are mainly given for the case where the detection object is a human and the seated state or the absence state is detected in a situation where the human faces the display unit 5 and operates the external input device 2, the present disclosure is not limited thereto.

For example, the present disclosure may be applied to a display device for providing information, which includes a relatively large monitor for providing information to a passerby and is configured to provide information depending on a button operated by the passerby when the passerby operates the button.

According to the information processing apparatus, the information processing method, and the information processing program disclosed herein, it is possible to dynamically update the information used as the determination criterion of the presence/absence of the detection object to an appropriate value depending on the change of the temperature environment. Thus, it is possible to accurately detect the presence/absence of the detection object.

1. An information processing apparatus, comprising:
an acquisition unit configured to acquire an output from a temperature sensor capable of outputting a signal depending on a temperature within a detection region;
an occupation information storage unit in which information relevant to a percentage of a detection object in the detection region is stored as occupation information;
a background temperature information storage unit in which background temperature information indicative a temperature of a background except for the detection object within the detection region; and
an information update unit configured to update either one information out of the occupation information and the background temperature information based on the output of the temperature sensor and the other information out of the occupation information and the background temperature information.

2. The information processing apparatus according to claim 1, further comprising a temperature sensor output information storage unit in which information depending on the output of the temperature sensor is stored as temperature sensor output information.

3. The information processing apparatus according to claim 1, further comprising a detection temperature information storage unit in which information indicative a temperature of the detection object is stored as detection object temperature information, wherein
the information update unit is configured to update the either one information out of the occupation information and the background temperature information based on the other information, the output of the temperature sensor, and the detection object temperature information.

4. An information processing apparatus, comprising:
an acquisition unit configured to acquire an output from a temperature sensor capable of outputting a signal depending on a temperature within a detection region;
a temperature sensor output information storage unit in which information depending on the output of the temperature sensor is stored as temperature sensor output information;
an occupation information storage unit in which information relevant to a percentage of a detection object in the detection region is stored as occupation information;
a background temperature information storage unit in which background temperature information indicative a temperature of a background except for the detection object within the detection region; and
an information update unit configured to update either one information out of the occupation information and the background temperature information based on the either one information and the temperature sensor output information.

5. The information processing apparatus according to claim 4, wherein
first temperature sensor output information as information depending on the output of the temperature sensor at a first time and second temperature sensor output information as information depending on the output of the temperature sensor at a second time prior to the first time are stored in the temperature sensor output information storage unit,
the information update unit is configured to take either one of the occupation information and the background temperature information as information to be updated, and is configured to update the information to be update based on the information to be update, the first temperature sensor output information, and the second temperature sensor output information.

6. The information processing apparatus according to claim 5, wherein the temperature sensor output information storage unit comprises a first temperature sensor output information storage unit in which the first temperature sensor output information is stored, and a second temperature sensor output information storage unit in which the second temperature sensor output information is stored.

7. The information processing apparatus according to claim 4, further comprising a detection object temperature information storage unit in which information indicative a temperature of the detection object is stored as detection object temperature information, wherein
the information update unit is configured to update the either one information out of the occupation information and the background temperature information based on the either one information, the temperature sensor output information, and the detection object temperature information.

8. The information processing apparatus according to claim 1, wherein the information update unit is configured to select the either one information out of the occupation information and the background temperature information as an update target depending on an amount of a change of the output of the temperature sensor.

9. The information processing apparatus according to claim 8, wherein the information update unit is configured to select the occupation information as the update target when a value based on the amount of the change of the output of the temperature sensor is greater than a preset threshold value, and is configured to select the background temperature information as the update target when the value based on the amount of the change of the output of the temperature sensor is equal to or smaller than the threshold value.

10. The information processing apparatus according to claim 1, further comprising a determination unit configured to determine presence and/or absence of the detection object within the detection region based on the occupation information.

11. The information processing apparatus according to claim 1, further comprising a determination unit configured to determine presence and/or absence of the detection object within the detection region based on the output of the temperature sensor and the background temperature information.

12. The information processing apparatus according to claim 1, further comprising an occupation information update unit configured to acquire a signal output from an external input device and to update the occupation information stored in the occupation information storage unit depending on the signal output from the external input device.

13. The information processing apparatus according to claim 12, wherein the occupation information update unit is configured to update the occupation information to a preset reference value when the occupation information update unit acquires the signal from the external input device.

14. The information processing apparatus according to claim 12, wherein the external input device is any one of a mouse, a keyboard, a touch panel, and a vibration detection device.

15. The information processing apparatus according to claim 1, further comprising the temperature sensor.

16. The information processing apparatus according to claim 1, wherein the temperature sensor is configured to output the signal depending on an absolute amount of the temperature within the detection region.

17. The information processing apparatus according to claim 16, wherein the temperature sensor is configured to output the signal depending on the absolute amount of the temperature within the detection region rather than the signal depending on a temperature change of the detection region.

18. The information processing apparatus according to claim 16, wherein the temperature sensor is any one of a thermoelectromotive force type infrared sensor, a conductivity type infrared sensor, a photoconduction type infrared sensor, and a photovoltaic type sensor.

19. An information processing apparatus, comprising:
an acquisition unit configured to acquire an output from a temperature sensor capable of outputting a signal depending on an absolute amount of temperature within a detection region;
a first information storage unit in which a first information is stored;
a background temperature information storage unit in which background temperature information indicative a temperature a background except for the detection object within the detection region; and
an information update unit configured to update either one information out of the first information and the background temperature information based on the output of the temperature sensor and the other information out of the first information and the background temperature information.

20. An information processing apparatus, comprising:
an acquisition unit configured to acquire an output from a temperature sensor capable of outputting a signal depending on an absolute amount of a temperature within a detection region;
a first information storage unit in which a first information is stored;
a background temperature information storage unit in which background temperature information indicative a temperature of a background except for the detection object within the detection region; and
an information update unit configured to update either one information out of the first information and the background temperature information based on the either one information and the output of the temperature sensor.

21. The information processing apparatus according to claim 19, wherein the first information is information unrelated to the temperature.

22. The information processing apparatus according to claim 21, wherein the information update unit is configured to select the first information as an update target when a value based on an amount of a change of the output of the temperature sensor is greater than a preset threshold value, and is configured to select the background temperature information as the update target when the value based on the amount of the change of the output of the temperature sensor is equal to or smaller than the threshold value.

23. The information processing apparatus according to claim 19, further comprising a determination unit configured to determine presence and/or absence of the detection object within the detection region based on the first information.

24. The information processing apparatus according to claim 19, further comprising a determination unit configured to determine presence and/or absence of the detection object within the detection region based on the output of the temperature sensor and the background temperature information.

25. The information processing apparatus according to claim 19, the temperature sensor is configured to output the signal depending on an absolute amount of the temperature within the detection region rather than the signal depending on a temperature change of the detection region.

26. The information processing apparatus according to claim 25, wherein the temperature sensor is any one of a thermoelectromotive force type infrared sensor, a conductivity type infrared sensor, a photoconduction type infrared sensor, and a photovoltaic type sensor.

27. An information processing method, comprising:
acquiring an output from a temperature sensor capable of outputting a signal depending on a temperature within a detection region; and
updating either one information out of occupation information stored in an occupation information storage unit and background temperature information stored in a background temperature information storage unit based on the output of the temperature sensor and the other information out of the occupation information and the background temperature information, the occupation information indicating information relevant to a percentage of a detection object in the detection region, and the background temperature information indicating a temperature of a background except for the detection object within the detection region.

28. An information processing method comprising:
acquiring an output from a temperature sensor capable of outputting a signal depending on a temperature within a detection region; and
updating either one information out of occupation information stored in an occupation information storage unit and background temperature information stored in a background temperature information storage unit based on the either one information and a temperature sensor output information stored in a temperature sensor output information storage unit, the occupation information indicating information relevant to a percentage of a detection object in the detection region, the background temperature information indicating a temperature of a background except for the detection object within the detection region, and temperature sensor output information depending on the output of the temperature sensor.

29. An information processing method comprising:
acquiring an output from a temperature sensor capable of outputting a signal depending on an absolute amount of a temperature within a detection region; and
updating either one information out of first information stored in a first information storage unit and background temperature information stored in a background temperature information storage unit based on the output of the temperature sensor and the other information out of the first information and the background temperature information, the background temperature information indicating a temperature of a background except for the detection object within the detection region.

30. An information processing method comprising:
acquiring an output from a temperature sensor capable of outputting a signal depending on an absolute amount of a temperature within a detection region; and
updating either one information out of first information stored in a first information storage unit and background temperature information stored in a background temperature information storage unit based on the either one information and the output of the temperature sensor, the background temperature information indicating a temperature of a background except for the detection object within the detection region.

31. A non-transitory computer readable medium storing an information processing program for causing a computer to execute the information processing method according to claim 27.

32. A non-transitory computer readable medium storing an information processing program for causing a computer to execute the information processing method according to claim 28.

33. A non-transitory computer readable medium storing an information processing program for causing a computer to execute the information processing method according to claim 29.

34. A non-transitory computer readable medium storing an information processing program for causing a computer to execute the information processing method according to claim 30.
